(19) United States
(12) Patent Application Publication
(10) Pub. No.: US 2018/0365639 A1
(43) Pub. Date: Dec. 20, 2018

(54) System and Method for Delivery of Ordered Goods

(71) Applicants: John Simms, Mclean, VA (US); Noel Simms, Jackson, MS (US); John Simms, JR., Arlington, VA (US)

(72) Inventors: John Simms, Mclean, VA (US); Noel Simms, Jackson, MS (US); John Simms, JR., Arlington, VA (US)

(21) Appl. No.: 15/626,506

(22) Filed: Jun. 19, 2017

(51) Int. Cl. G06Q 10/08

(52) U.S. Cl. CPC G06Q 10/0836

(57) ABSTRACT

An improved method for the delivery to or pick-up from a locked storage container-of an ordered item comprising determining the availability of the container to receive a delivery or allow a pick-up; identifying a time interval during which the delivery and/or pick-up can be effected; sending a signal to the storage container allowing access by a delivery/pick-up agent, the improvement including the steps of preparing invitations to bid for the delivery and/or pick-up; distributing, receiving, and evaluating the bids from a pool of delivery/pick-up agents in an auction; and selecting a delivery/pick-up agent.

### BACKGROUND OF INVENTION

### 1. Field of the Invention

The invention relates to a system, device and method for receiving goods or other items, purchasing goods, scheduling and tracking deliveries and pick-ups, receiving deliveries or picking up ordered items utilizing a specialized device, making and processing payment, inventorying items scheduled for delivery and items delivered and making information about deliveries available through a variety of means.

### 2. Discussion of the Prior Art

The recent upsurge in e-commerce whereby a consumer accesses a website over the Internet to purchase goods for delivery to the home, office or other site has created a need for secure systems/methods for scheduling and tracking deliveries of the purchased items, as well as for providing a safe and secure site for receipt of the goods when they are delivered to an unoccupied site. The convenience of being able to avoid making trips to a brick and mortar store or outlet to purchase goods, and having the goods delivered to home, office or other site is off-set by the problems surrounding the secure delivery of the goods to the purchaser. If the purchaser is not available on-site to receive the goods, delivery must either be re-scheduled or the goods must be left unsecured at the site, thereby being subject to theft or damage.

U.S. Pat. No. 6,933,832, the entire contents and disclosure of which are incorporated by reference herein, describes a system and method which enables the delivery, and safe and secure receipt of purchased items or other goods, at an unattended site.

The patented method and system enables the delivery to and/or pick-up from a locked storage container, associated with a corresponding customer, of at least one purchased or ordered item, the method comprising, following the purchase or order of the at least one item, determining the availability of the locked storage container to effect the delivery and/or pick-up at one or more times, identifying a time interval during which the delivery and/or pick-up can be made, and sending to the locked storage container an access signal allowing a delivery agent access to the locked storage container only during the time interval for delivery thereto of the at least one item.

Copending patent application Ser. No. 14/544,035, filed Feb. 2, 2015, describes an improvement in the patented system wherein the delivery agent is a drone aircraft.

In the patented system, knowledge of the delivery agent, the agent's qualifications for completing a successful delivery and the price of delivery of the ordered good(s) is necessary for the purchasers and sellers of the good(s), before a commitment is made to purchase. Moreover, the availability of multiple sources of delivery agents from which to choose would enhance the overall quality and efficiency of the purchase/delivery transaction.

### SUMMARY OF THE INVENTION

The present invention relates to improved methods and systems for the delivery to or pick-up from at least one locked storage container associated with a corresponding customer of at least one ordered or purchased item comprising, following the ordering of the delivery, determining the availability of the at least one locked storage container to receive the delivery and/or allow the pick-up at one or more times; identifying a time interval during which the delivery and/or pick-up can be effected; sending a signal to the at least one locked storage container allowing access by a delivery and/or pick-up agent only during the time interval, the improvement comprising the incorporation therein of a method and system, respectively, for preparing invitations to bid for delivery and/or pick-up of the ordered or purchased goods; distributing, receiving, and evaluating the bids from a pool of delivery/pick-up agents in an auction; and selecting a delivery/pick-up agent.

### DESCRIPTION OF THE DRAWINGS

FIG. 1 is an elevational view of a storage container.

FIG. 2 is a flow sheet depicting the steps of the method of the invention overlaid on the main components or participants in the method.

FIG. 3 is an elevational view of the front of a storage container.

FIG. 4 is an elevational view of the rear of a storage container.

FIG. 5 is a cut-away view of the interior of a storage container.

FIG. 6 is a block diagram of a system utilizing a computer as the controller between the electronic key to the storage appliance and the communications network.

FIG. 7 is a simplified flow chart of the delivery method.

FIG. 8 is a block diagram depicting an auction system, in accordance with certain example embodiments.

FIG. 9 is a block diagram depicting an exemplary collection of performance data histories for use in evaluating auction bids.

FIG. 10 is a diagram depicting a system for conducting an auction in accordance with an embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention is predicated on the unexpected discovery that the method for the delivery to or pick-up from a locked storage container of at least one purchased or ordered item, associated with a corresponding customer, the method comprising, following the purchase or order of the at least one item, determining the availability of the locked storage container to receive the delivery and/or allow the pick-up at one or more times, identifying a time interval during which the delivery and/or pick-up can be effected, sending to the locked storage container an access signal allowing a delivery/pick-up agent access to the locked storage container only during the time interval for delivery thereto and/or pick-up therefrom of the at least one item can be vastly improved where delivery to the locked storage container comprises a system and method wherein the delivery/pick-up agent is selected from a group consisting of bidders in an auction of the delivery/pick-up of the ordered item.

The method of the invention is predicated on the provision of at least one locked storage container which is accessible by means of an identifier which unlocks an entry door to the interior of the locked storage container.

It will be understood by those skilled in the art that an “identifier” includes a physical device, such as a key, electronic key, smart card, magnetic card, or similar device carried or transported by a delivery agent; a biometric property such as fingerprint, voice recognition, retinal scan of a delivery person; wireless communication options such as any duplex, half-duplex, or full-duplex communication method including but not limited to: Near Field Communications (NFC), WiFi, Bluetooth, Radio, RFID, Mesh Networking Protocols (i.e. FabFi, G.hn, etc.), Ethernet, Telephone, Fiber Optic, Optical, Barcode, QR Code, or any combination of methods, or any other element which operates to unlock the appliance, locker or device upon being sensed and identified by the latter.

According to the improved method of the invention, identification may be supplied by the delivery agent. A typical location for the locked storage container is near or affixed to the exterior of a home or office. The locked storage container is capable of receiving and storing goods for delivery or pickup with a level of security preventing unauthorized entry or theft and with protection against pests and unfavorable weather conditions. The locked storage container may be equipped with multiple storage areas, some of which may be cooled, heated or insulated. The container may be free-standing, secured to a fixed location or affixed to a structure.

The locked storage container is preferably in electronic communication with a computer or computer network by any of a variety of means, including, but not limited to a telephonic signal, television cable, computer network cable, radio signal or the like.

The locked storage container receives and transmits data to the computer or computer network via a “scheduler” which is capable of organizing and recording a schedule of deliveries and pickups utilizing the appliance, locker or device and transmitting instructions to the appliance allowing it to identify an identifier authorized to access the appliance in accordance with a schedule. The locked storage container is preferably identifiable by the computer or computer network with which it is communicating by identification number, name or location. Each locked storage container is also preferably associated with a particular customer's account records.

Still another embodiment of the invention comprises a method and system of scheduling and tracking deliveries, of receiving deliveries utilizing a specialized device, of making and processing payment, of inventorying items scheduled for delivery and items delivered and of making information about deliveries available through a variety of means. Users of the method and system may be entities desiring to make deliveries and/or to receive deliveries. Users of the method and system may schedule delivery, track shipment and delivery, make secure delivery via a specialized appliance, locker or device, make and confirm payment, inventory items scheduled for delivery and delivered. Users of the method and system may access data regarding the appliance, device or locker and/or delivery location stored on the computer or computer network and accessed by a variety of means including telephone, radio, computer network or the Internet. The type of data which may be accessed includes, but is not limited to, data concerning the location of the locked storage container and alternative delivery locations, the capacity and type of storage of the appliance, the type and availability of storage capacity at the time and date of intended delivery and special instructions or other information pertaining to the delivery appliance and location and method of payment.

The present invention may alternately be described as a method or system of delivery to one of a plurality of locked storage containers, each associated with a corresponding customer, using a delivery system including a scheduler, the steps including: ordering a first delivery of one or more goods for a first customer associated with a first locked storage container of the plurality of locked storage containers; following the ordering of the first delivery, determining the availability of the first locked storage container to receive the first delivery at one or more times by use of the scheduler; identifying, using the scheduler, a first time interval during which the first delivery can be made; and the delivery system sending to the first locked storage container an access signal allowing a first delivery agent which is delivering the delivery to access the first locked storage container only during the first time interval. The steps include: ordering a second delivery of one or more goods for the first customer; following the ordering of the second delivery, determining the availability of the first locked storage container to receive the second delivery at one or more times by use of the scheduler; identifying, using the scheduler, a second time interval during which the second delivery can be made; and the delivery system sending to the first locked storage container an access signal allowing a second delivery agent which is delivering the second delivery to access the first locked storage container only during the second time interval.

A delivery can be ordered for one or more goods for a second customer associated with a second locked storage container of the plurality of locked storage containers. Following the ordering of the last-mentioned delivery, the availability of the second locked storage container to receive the last-mentioned delivery at one or more times by use of the schedule is determined. The method identifies, using the scheduler, a second customer time interval during which the last-mentioned delivery can be made; and the delivery system sends to the second locked storage container an access signal allowing a delivery agent which is delivering the last-mentioned delivery to access the second locked storage container only during the second customer time interval. The first delivery agent opens the first locked storage container using an identifier corresponding to the first delivery agent and the second delivery agent opens the first locked storage container using an identifier corresponding to the second delivery agent.

Following the ordering, the size of the delivery is determined using the delivery system. Available room within the first locked storage container is checked by use of the delivery system. Upon availability as indicated by the checking step, the delivery system reserves sufficient room within the first locked storage container to receive the delivery.

Following the first delivery, an account of the first customer is charged for the first delivery to the first locked storage container signaling the delivery system of the insertion of the first delivery into the first locked storage container. The first locked storage container signals the delivery system of the insertion of the first delivery into the first locked storage container based on access by the first delivery vehicle.

The invention may alternately be described as a method and system of delivery of ordered items to a plurality of locked storage containers by delivery agent using a delivery system, the steps including: ordering a delivery of one or more goods to a first customer; following the ordering, determining the size of the delivery using the delivery system; checking available room within a first locked storage container of the plurality of locked storage containers, the first locked storage container corresponding to the first customer, by use of the delivery system; upon availability, reserving, by operation of the delivery system, sufficient room within the first locked storage container to receive the delivery; and delivering the delivery to within the first locked storage container. Upon finding that the available room within the first locked storage container is insufficient for the size of the delivery, the ordered delivery is divided into at least first and second partial deliveries for separate delivery upon there being available room. The delivery system includes a scheduler and the method further includes the steps of: following the ordering of the delivery, determining the availability of the first locked storage container to receive the first and parts at one or more times by use of the scheduler; identifying, using the scheduler, a first time interval during which the first partial delivery can be made and a second time interval during which the second partial delivery can be made; and the delivery system sending to the first locked storage container an access signal allowing access to the first locked storage container only during the first time interval for delivery of the first partial delivery and during the second time interval for delivery of the second partial delivery. Prior to dividing the ordered delivery, input is received from the customer indicating the customer's preference for a complete delivery or delivery in multiple portions; and the scheduler schedules delivery according to the customer's preference. The method of further includes the step of: charging an account of the first customer for a delivery upon the locked storage container signaling the delivery system of the insertion of a delivery into the locked storage container.

The invention may alternately be described as a method for delivery of ordered items to a plurality of locked storage containers by delivery agents using a delivery system, the steps including: ordering a delivery of one or more goods to a customer; delivering the delivery to within one of the locked storage containers corresponding to the customer; and automatically sending a DELIVERY MADE signal from the one of the locked storage containers signaling the delivery system of the insertion of the delivery into the one of the locked storage containers. Upon the delivery system receiving the DELIVERY MADE signal, the delivery system performs one or more steps selected from the group consisting of: charging an account of the customer for the delivery; and automatically initiating a communication to the customer. The delivery system includes a scheduler and further includes the steps of: following the ordering, determining the availability of the one of the locked storage containers to receive the delivery at one or more times by use of the scheduler; identifying, using the scheduler, a first time interval during which the delivery can be made; and the delivery system sending to the one of the locked storage containers an access signal allowing a first delivery agent which is delivering the delivery to access the one of the locked storage containers only during the first time interval. The method further includes the steps of: following the ordering, determining the size of the delivery using the delivery system; and checking available room with the one of the locked storage containers by use of the delivery system.

The delivery system of the present invention may be described as including: at least one locked storage container corresponding to a customer, an order receiver for receiving orders for delivery by a delivery agent of one or more goods for customer; availability determiner for determining the availability of the locked storage container to receive deliveries at one or more times; a scheduler receiving availability information from the availability determiner and operable to identify a time interval during which the delivery can be made and operable to send to a locked storage container an access signal allowing a delivery agent that is delivering a delivery to access the locked storage container only during the time interval identified by the scheduler, wherein the storage container is equipped with an element for receiving the access signal.

The locked storage container of the present invention is an appliance equipped as described above with means for a delivery agent to securely deliver goods/items therein, without requiring a person in attendance to accept delivery and which includes: a storage container; a lock controlling access to the storage container; and a communication link connected to the lock and operable to receive an access signal from a remote location to allow access to the storage container; and wherein the lock is responsive to the communication link receiving the access signal by unlocking upon presentation of an identifier such as described above.

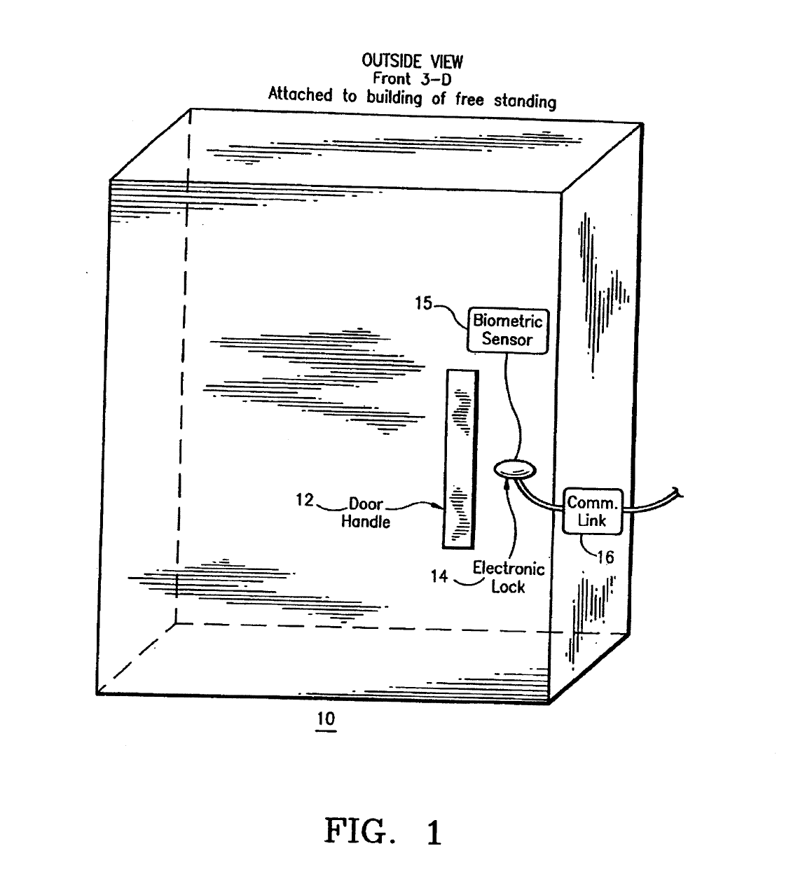

FIG. 1 shows an appliance 10 according to the present invention. The appliance 10 is a locked storage container with a door handle 12 and an electronic lock 14. The lock 14 may be accessed by a universal key, other physical device or other identifier (including biometric properties as discussed above). The lock 14 is capable of identifying electronically or by other means the key (more generally the identifier) being used for unlocking or opening the appliance. However, in the preferred design the appliance 10 is capable of identifying specific keys authorized for entry and/or permitting access by unlocking the door based on instructions communicated to it by a scheduler, remotely located. The scheduler is connected to lock 14 via communications link 16 such as a modem or other interface to the telephone system, the interne or other communications, and discussed in more detail below. The appliance is also capable of denying entry to keys not authorized for delivery or not authorized for delivery at that time. The appliance is preferably capable of recording and/or transmitting a log or other itemized listing of authorized and unauthorized attempt(s) at opening the appliance and may include among other information the electronic identity of each key, the date and time of the attempt.

The access to appliance 10 may be explained by an example. A first delivery agent working for a first company may have an electronic key, such as a smart card or magnetic card, unique to that vehicle. Alternately, and in lieu of the key or other physical access device, a biometric property (such as fingerprint, voice pattern, retinal pattern) of the delivery agent may be read by an optional biometric sensor 15. A second delivery agent working for a second company may have an electronic key, such as a smart card or magnetic card, unique to the second company. The first delivery agent may be scheduled for accessing the appliance 10 during a first time interval such as between 9 AM and 12 noon on a given day, whereas the second delivery agent may be scheduled for accessing the appliance 10 during a second time interval such as between 1 PM and 4 PM on the same day. Under such circumstances, the lock 14 could only be opened by the first delivery agent's electronic key (not shown) during the first time interval, whereas the lock 14 could only be opened by the second delivery agent's electronic key (not shown) during the second time interval. This assumes that the scheduler switches the lock 14 into an access state in which it is unlockable by an electronic key. Alternately, the scheduler could simply unlock the lock 14 so that a delivery agent could insert items in the appliance without needing a lock.

The time intervals might be much longer then the several hour time intervals above. For example, a time interval of 24 or more hours for a delivery might be used. Further, the first and second time intervals might overlap or even be identical (i.e., two deliveries scheduled for the same time interval).

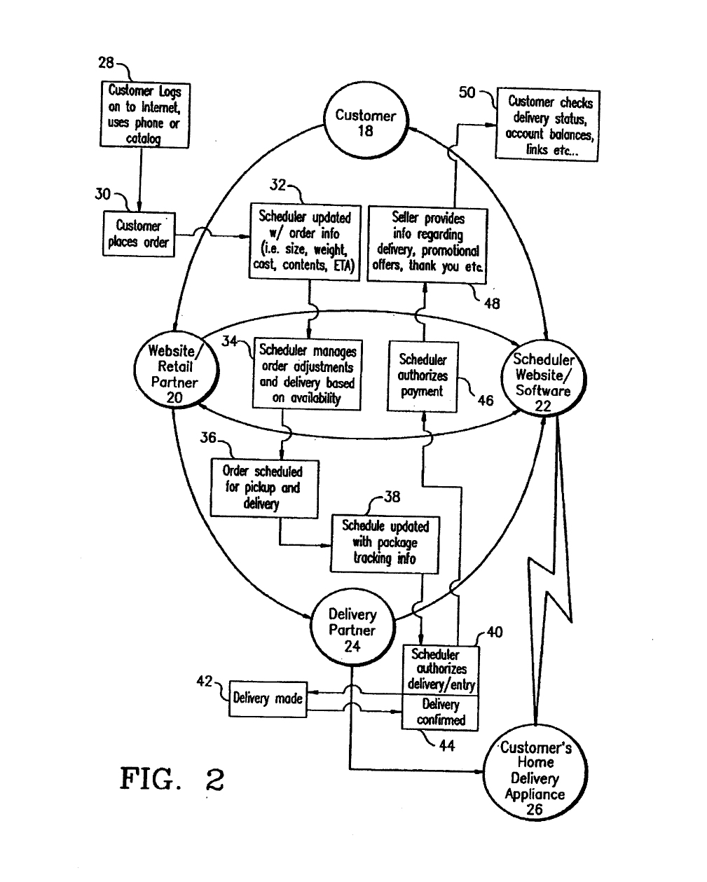

In a typical use of the device, system and method of the invention, and with particular reference to FIG. 2, a flow chart is shown overlaid on the main components or participants linked as shown. Discussing first, the main components or participants, the customer 18 is linked to website/retail partner 20 which in turn is linked to a scheduler website software 22 and delivery partner 24. The delivery partner 24 in turn is linked to website/retail partner 20 and also to the customer's home delivery attendant 26. The various illustrated links between 18, 20, 22, 24, and 26 would preferably be internet links, but telephone or other links could also be used for some or all of the links. It should be understood that the components 18 through 26 are shown for a particular customer, but in practice there would be a plurality of customers 18 each having an associated home delivery attendant 26. Additionally, the scheduler website/software may interact with a plurality of retail outlets 20 and a plurality of delivery partners 24. For example, there may be a retailer 20 for books, a different retailer 20 for clothing, and numerous other retailers, some competitive with others, all linked to the scheduler 22. The various delivery partners may be specialized on a geographic basis, a delivery basis (i.e., one delivers within one day, another delivers within three days, etc.), and possibly by the type of delivery being made. As will be discussed below, some orders may involve goods requiring special handling such as refrigeration in transit and the delivery partner delivering such goods may need a refrigerator section in a delivery truck.

Turning now to the flow chart part of FIG. 2, the steps are numbered 28 to 50, steps 40 and 44 being within a common box. At box 28, a consumer accesses an e-commerce website over the Internet to purchase goods for home delivery. The consumer identifies himself/herself as an account holder. The retailer/vendor 20 electronically looks up and verifies the account of the consumer against a register or database of accounts made available on-line by the scheduler 22. An account holder is an authorized user of an appliance(s) 10 (FIG. 1 only) capable of unattended receipt/delivery and of electronically communicating with a specialized computer program (scheduler) which schedules deliveries to the appliance and reports deliveries to the account holder. The consumer selects items for purchase and delivery and fills an electronic shopping cart.

It will be understood that the invention also contemplates delivery and/or pick-up of items ordered by telephone, mail, or in person at a retail store. The invention also may be used for receiving items that do not involve a commercial transaction. For example, a neighbor could return a borrowed item to the person owning the storage container.

As the shopping cart is loaded with goods selected, the estimated total size of the bundle of items as measured by the dimensions of height, width and depth is calculated (with software provided by the scheduler) based on information provided by the seller. Accessing information (provided by the scheduler over a computer network of the Internet) regarding the type and capacity of the appliance and the estimated remaining capacity of the appliance at the projected time/date of delivery, the estimated size of the bundle of items is compared against the total volume (including the various dimensions) of space remaining available in the consumer's designated appliance(s) on the time/date of the proposed date of delivery. Thus, an order that has a length of 5 feet will require 5 feet available within the appliance 10. If the volume or any dimension of the order exceeds available capacity, the consumer is given the option of splitting the delivery into two or more deliveries, of rescheduling the delivery for another time when capacity is available, or of removing items from the shopping cart.

The retailer or seller notifies the consumer of the final purchase price including shipping and handling. At step 30, the consumer authorizes the purchase and indicates method of payment. The consumer may arrange for payment to seller directly or by debit or credit accounts linked to the consumer's account. The seller finalizes the sale. At block 32, the seller notifies the scheduler 22 (a specialized computer program running on a delivery system computer) of the time/date of the intended delivery and the estimated size of the bundle of items. The scheduler reserves the capacity in the designated appliance for the scheduled time/date of the delivery. The seller also electronically provides to the scheduler (in format specified by the scheduler) an inventory of items purchased, itemized prices of each item purchased, itemized shipping and handling costs, and any other information permitted by the scheduler including coupon or “cents off” offers and other advertising and promotional information. This information provided by the seller may be made accessible by the scheduler to the consumer by a variety of means and formats, including computer networks, the Internet, electronic mail, telephone or printed matter.

The seller prepares the order for shipment. If any of the items are unavailable at the time that the order is being filled or if other items are added to the shipment for any reason, the estimated size of the bundle of items is adjusted. At step 34, the seller accesses information provided by the scheduler regarding the then available capacity at the time/date of delivery. If space is available, the shipment is scheduled at step 36. If space is unavailable, the shipment is adjusted interactively until available space capacity can be confirmed and reserved. At step 38, the seller electronically provides to the scheduler information to update the order, including any shipping information, routing or tracking numbers, etc., and any additional advertising or promotional information.

Preceding the time/date of each scheduled delivery, the scheduler communicates at step 40 electronic instructions to the appliance to permit entry to delivery personnel using a key which is identified by the appliance and matches a key authorized for entry for the scheduled delivery at that date/time (a time interval within an assigned date, or optionally, more than one date). If a key does not match a key authorized for entry at that time/date, entry will be denied. Once entry is gained for an authorized key, that key will be locked out until re-authorized.

When a delivery is made to the appliance 10 at step 42, the appliance communicates to the scheduler (by sending a “delivery made” signal) that the delivery was completed at step 44. Debit or credit sales at the point of delivery are processed for payment (costs of the goods and/or delivery applied to an account of the customer) at step 46. The scheduler updates the consumer's account with the time/date of receipt. The vendor selling the goods or service making the delivery may also provide information to the customer's account regarding the time/date of delivery, promotional material and other information specified above, including a “thank you” for the purchase at step 48.

The scheduler updates the consumer's account with various information regarding each purchase and scheduled delivery at step 50. The consumer may access this information through a variety of means including a computer network, an email, the Internet (i.e., checking a web page), a text message to the consumer's pager, or telephone. The consumer may review his/her account through a variety of views including available capacity by time period, committed capacity by time period, chronological list of scheduled deliveries, chronological list of scheduled deliveries by vendor, chronological list of scheduled deliveries by vendor classification (i.e., groceries, dry cleaning, etc.), deliveries made, deliveries missed, inventory of items ordered or delivered (by vendor, vendor classification, time period, etc.), inventory of items ordered but not shipped, calculation of costs (by vendor, vendor type, time period, method of payment, shipping and handling, etc.).

The consumer account holder may request to be notified at various stages of the shipping and delivery process. In addition to information, which is updated to the consumer's account and available by means previously specified, the notification may be made via electronic mail, voice or text pager, Of telephone, smart phone, Ipad type device or an app.

Although the discussion refers to consumers placing the orders, it will be understood that the person ordering may also be a business customer ordering supplies for a business.

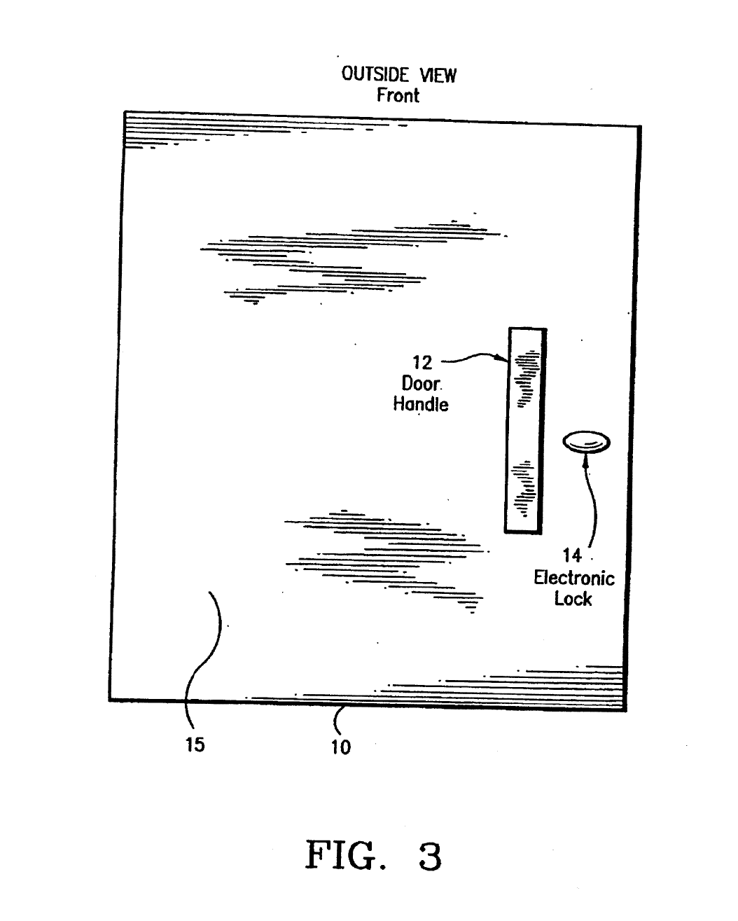

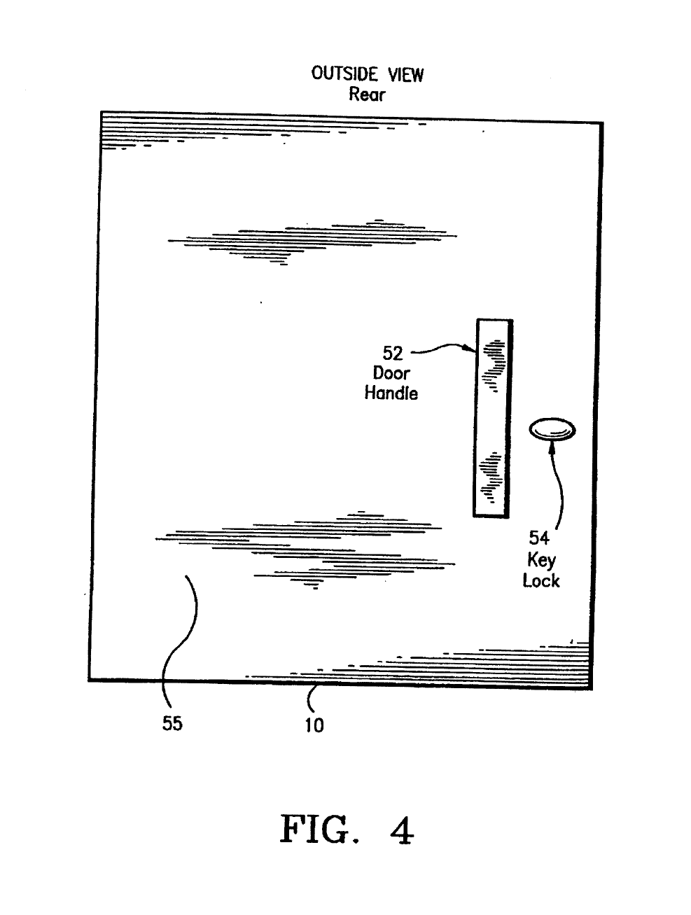

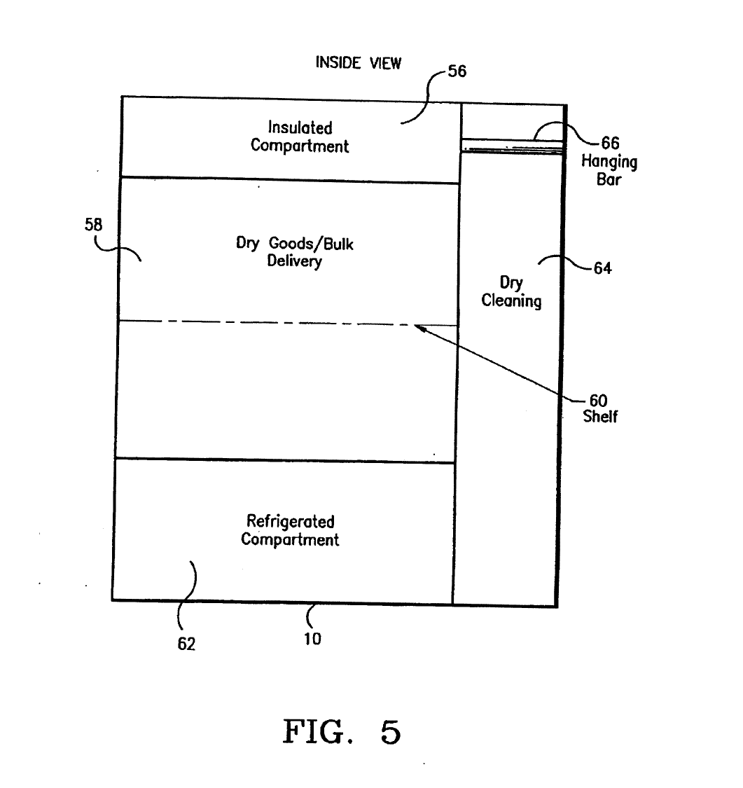

Turning now to FIGS. 2-5, the appliance 10 details will be discussed. Door handle 12 and electronic lock 14 are on the front of the appliance 10 and would be used by delivery persons to access the appliance via a front door 15. Door handle 52 and key lock 54 would be used by the customer (i.e., appliance owner) to access the rear door 55 of the appliance 10. In practice, the appliance 10 may have its front door 15 on the outside of a house (not shown) with the rear door 55 on the inside of the house. In that case, the appliance would fit in an opening in the wall of the house in similar fashion to some room air conditioners. The inside of the appliance 10 includes an insulated compartment 56 where items such as hot food (pizza, etc.) may maintain their heat. Dry goods or bulk items may be placed within compartment 58 which is subdivided by a shelf 60. A refrigerated compartment 62 and dry cleaning section 64 with a bar 66 for hanging clothes are also included. Although not separately shown, a heated compartment and a freezer compartment may also be included.

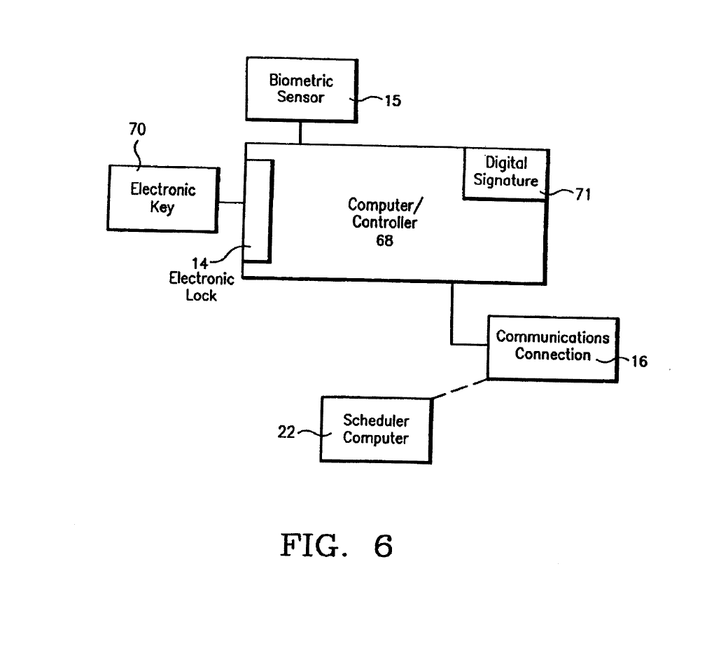

Turning now to FIG. 6, the electronic lock 14 is connected to a computer/controller 68 that is in the appliance 10. The computer/controller 68, which may operate solenoids or other actuators (not shown) in order to unlock lock 14 or render it accessible (i.e., ready to be unlocked) via electronic key 70, communicates via communication link 16 with the scheduler 22. The link 16 may connect to scheduler 22 via the internet, telephone system, cable, wireless or other technique.

A digital signature 71 may be stored within computer 68 and may be used for acknowledging special deliveries. For example, the delivery of certain pharmaceutical goods may require a signature to acknowledge receipt. Upon the insertion of a pharmaceutical delivery (or any other delivery where signature is desired or required), the computer 68 may send, as part of a DELIVERY MADE signal, an appended digital signature to authenticate the delivery. Alternately, the electronic key 70 may be part of or connected to a small computer carried by the delivery person and operable to receive the digital signature acknowledging receipt of the delivery. Recent changes in the law in the United States, among other countries, may allow such digital signatures to be used in situations where written signatures were previously used.

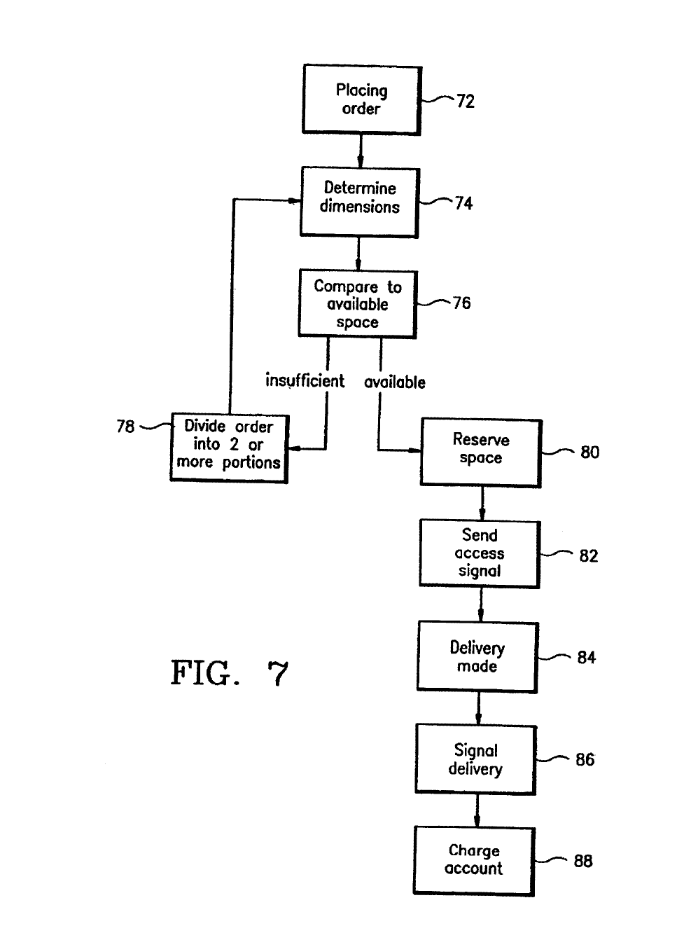

Turning now to FIG. 7, but also considering FIG. 2, a flow chart of some key aspects of the method of the present invention will be discussed. Except as otherwise noted the steps in FIG. 7 are performed by scheduler 22. The order is placed at step 72 by a customer on his/her computer which communicates it to the scheduler 22. At block 74, the scheduler 22 determines the dimensions of the order. These dimensions may have been supplied to scheduler 22 by the retailer 20. At block 76, the scheduler 22 compares the dimensions of the order with the available space within the appliance 10 for a given time period. The scheduler may keep a running total of space available within the appliance. Alternately, the computer 68 of FIG. 6 may keep a running total of space available that is supplied, upon automated request, to the scheduler.

If block 76 determines that not enough space is available, control goes to block 78 where the order is divided into two or more portions for separate delivery before returning to block 74.

Once block 76 determines that sufficient space is available, control goes to block 80 where space for the delivery is reserved. Next, block 82 sends an access signal from the scheduler 22 to the appliance 10 such that a delivery vehicle may unlock it during a prescribed time interval. Block 84 indicates that the delivery is made, after which block 86 corresponds to the computer 68 of the appliance 10 sending a delivery made signal to the scheduler. Upon receipt of the signal indicating delivery, the scheduler 22 or another part of the delivery system computer on which the scheduling software runs, sends a charge account signal. The charge account signal debits or charges the customer's account for the delivery which had just been made.

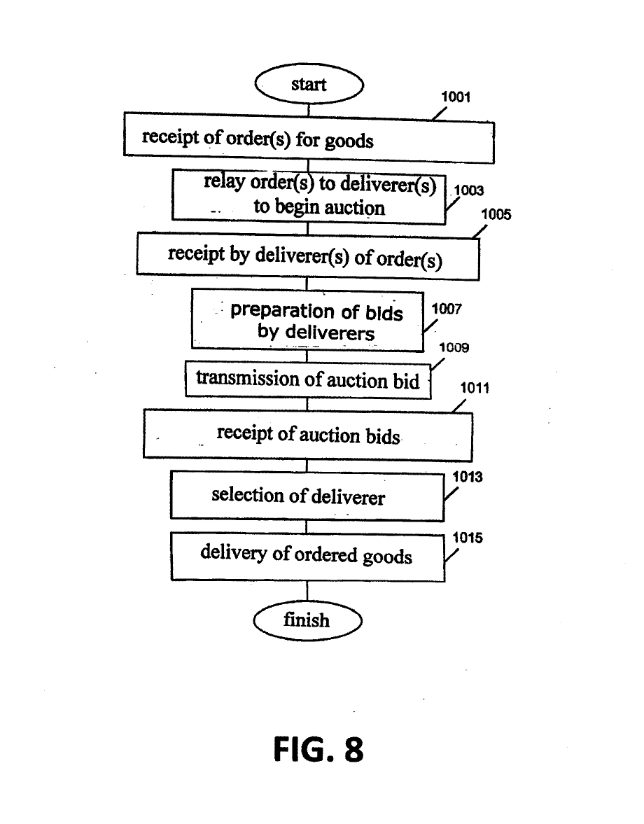

FIG. 8, considered in conjunction with FIGS. 2 and 7, is a block diagram of some preferred aspects of the method and system of the present invention. At block 1001, the order or purchase of the goods to be delivered to the locked storage container(s) is received. The order or purchase will include information as to the location of the container(s), preferred times of delivery of the goods thereto, and the like. At block 1003, invitations to bid in an auction for delivery of the goods are conveyed to a pool of delivery agents. In a preferred embodiment, the invitations are transmitted by a computerized system through a website, and may take the form of an email, a text message, an electronic message, and the like. The invitations may take any desired or convenient form, listing all of the parameters to be considered for the delivery such as, for example, price of delivery range, nature and size of goods, time frame of delivery, deadline for submitting bids, and the like. Block 1005 indicates receipt by the delivery agents of the invitations to bid. It will be apparent to those skilled in the art that the pool of delivery agents have ready access to the preferred website described above. At block 1007, those delivery agents in the pool to which invitations were sent, prepare their bids based on considerations of the nature and cost of delivery, the time of delivery and their availability to make the delivery, and the like. At block 1009, the delivery agents participating in the auction deliver their bids to the origin of the purchased or ordered goods. Block 1011 indicates receipt by the origin of the purchased or ordered goods of the delivery agents' bids. In a preferred embodiment, the bids are received through a website. The bids will include information about costs, times and any other parameters set forth above in the description of block 1003 in the invitations to bid. At block 1013, the originator of the bids selects the delivery agent at the end of the time period for bidding. The selection may be accomplished utilizing any convenient formula or algorithm suitable for such purposes. One of the critical factors in making the selection is the reputation and performance history of the delivery agent. Therefore, the method and system of the invention includes the collection of data from prior invitations, prior bids received from bidders, and prior performances of accepted bids and contracts by bidders, and the archiving of such data in a database on which the selection of delivery agent may be based. As indicated at block 1015, delivery according to the improved system and method of the invention is effected by the selected bidder.

It will be recognized by those skilled in the art that any desired and suitable auction system may be employed in the practice of the invention. Exemplary, but not exhaustive of suitable systems are a traditional English auction, a reverse auction, a forward auction, a Yankee auction, a multiple-item Dutch auction, a Chinese auction, an absolute auction, a minimum-bid auction, a reserve auction, a first-price-sealed-bid auction, a second-price-sealed-bid auction, a multi-par bidding auction, a silent auction, a secret auction, or an open auction.

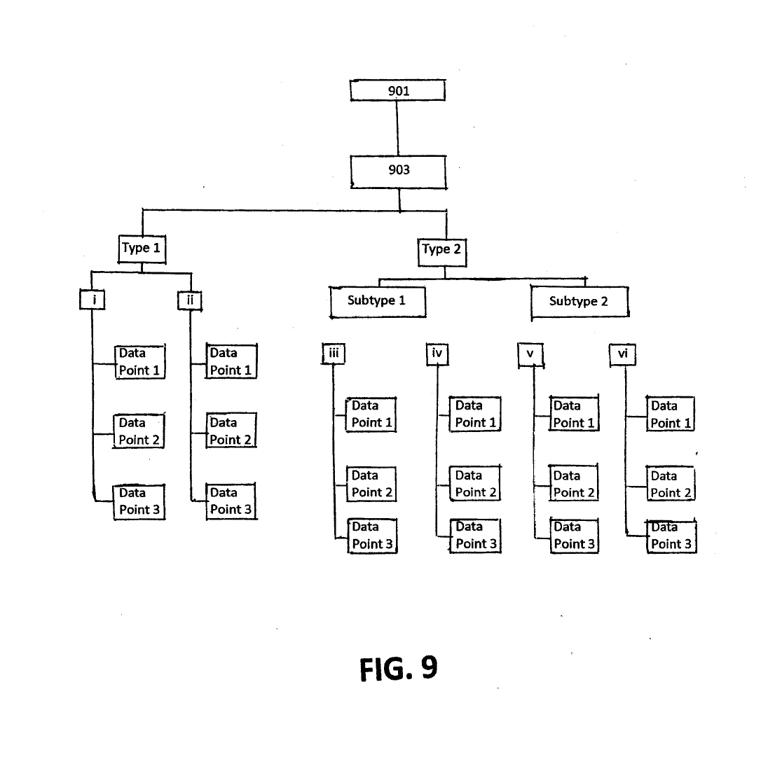

FIG. 9, considered in conjunction with FIGS. 2, 7, and 8, illustrates the data format and structure of information 900 collected and maintained for evaluating bids from delivery agents participating in an auction conducted in accordance with an embodiment of the invention. Information relating to prior auction bids and deliveries previously performed in accordance with the system and method of the invention by members i, ii, iii, iv, v, vi, vii, etc. of a pool 903 of delivery agents is stored in database 901. In accordance with a preferred embodiment of the invention, goods to be delivered are categorized as Type 1, Type 2, and so on. For example, the goods to be delivered could be typed as bulk liquids, solids, particulate matter, and the like.

Those skilled in the art will appreciate that the system and method of the invention are amenable to any kind of characterization of the goods to be delivered.

In some cases, it may be desirable to further subdivide the Types into Subtypes 1, 2, etc. For example, a Type 2 solid could be Subtyped as refrigerated, and the like. It will be appreciated by those skilled in the art that any hierarchical system of classifying the kinds of deliveries and goods may be employed in the practice of the invention.

The past bids and aspects of the delivery performances of the various delivery agents, i, ii, iii, . . . are represented in FIG. 9 by Data Point 1, Data Point 2, Data Point 3, and so on. Data Point 1 may refer to bid price, for example. Data Point 2 may represent a grade for timeliness of delivery. Data Point 3 could indicate the satisfaction or lack thereof by the owner of the locked storage container to which the ordered or purchased goods were delivered. Those skilled in the art that be aware that the number and kinds of Data Points to be included in any embodiment of the invention is limited only by the imagination of the user thereof.

The historical data contained in database 901 is relied upon to evaluate those bidding in the auction conducted in the practice of the system and method of the invention in order to select the best possible option for delivery of the ordered or purchased goods.

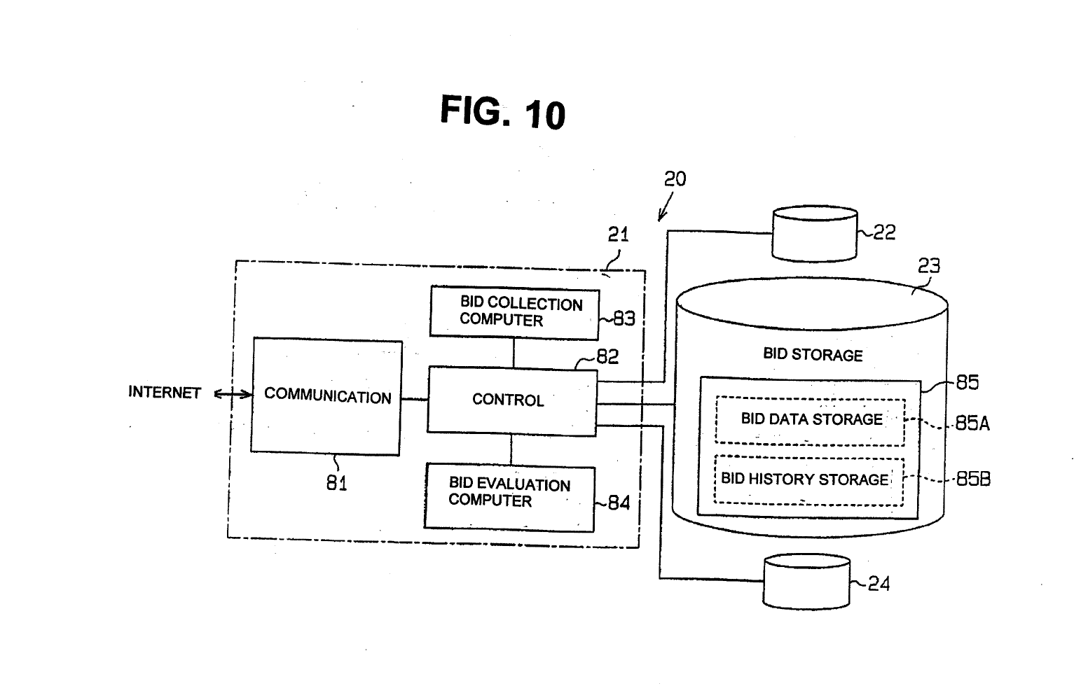

A preferred embodiment of an auction system which comprises part of the improved system and method of delivery of ordered or purchased goods to locked storage containers comprising the present invention is illustrated in FIG. 10.

As illustrated in FIG. 10, taken in conjunction with FIGS. 2, 7, 8, and 9, a preferred auction system 20 comprises a server 21, which is connected to three databases 22, 23, and 24, and to the Internet, and further connected to terminals (not shown) of members of a pool of potential delivery agents, for communications therewith through the Internet. The server 21 illustrated in FIG. 10 stores an auction program which communicates to members of the pool of delivery agents through the Internet or other electronic means invitations to bid in an auction. The respective members of the pool prepare their bids and communicate the bids to the server 21 As further illustrated in FIG. 10, the auction system 20 comprises a communication element 81, a control element 82, a bid collection computing element 83, and a bid evaluation computing element 84. The communication element 81, control element 82, bid collection computing element 83 and bid evaluation computing element 84 are implemented by the server 21. In a preferred embodiment of the invention, the communication element 81 functions according to a predetermined communication protocol; e.g., (HTTP). A storage system 23, comprising a bid storage element 85 which is further comprised of a bid data storage element 85A and a bid history storage element 85B. The control element 82 and the respective computing elements 83 and 84 are employed for computing a successful bidder in the auction from the data stored in the respective storage elements 85A and 85B.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. An improved method for the delivery to and/or the pick-up from at least one locked storage container associated with a corresponding customer, of at least one ordered or purchased item comprising, determining the availability of the at least one locked storage container to effect the delivery and/or pick-up at one or more times; identifying a time interval during which the delivery and/or pick-up can be effected; sending a signal to the at least one locked storage container allowing access to the at least one locked storage container by a delivery agent that is delivering and/or picking up the at least one ordered item only during the time interval, the improvement including the steps of preparing invitations to bid for delivery to and/or pick-up from the at least one locked storage container of the at least one ordered or purchased item; distributing to and receiving bids from a pool of delivery agents in an auction; evaluating the bids and selecting a delivery agent.

2. The method of claim 1 wherein the auction comprises:
submitting invitations to a pool of potential delivery agents to bid on delivering to and/or picking up from said at least one locked storage container said at least one purchased or ordered item;
receiving bids from members of said pool to effect said delivery and/or pick-up;
evaluating said bids to determine the identity of the delivery agent selected to effect said delivery and/or pick-up;
selecting a delivery/pick-up agent; and
transmitting authorization to said selected delivery agent to effect said delivery and/or pick-up.

3. The method of claim 2 wherein said evaluation of said bids is based on data collected from prior invitations, prior bids received from bidders, and prior performance of accepted bids and contracts by bidders.

4. The method of claim 3 wherein, during said delivery and/or pick-up, the performance of said delivery agent is monitored and the data obtained therefrom added to said data collection.

5. The method of claim 1 wherein said auction comprises a traditional English auction, a reverse auction, a forward auction, a Yankee auction, a multiple-item Dutch auction, a Chinese auction, an absolute auction, a minimum-bid auction, a reserve auction, a first-price-sealed-bid auction, a second-price-sealed-bid auction, a multi-par bidding auction, a silent auction, a secret auction, or an open auction.

6. A computer-implemented method of claim 1.

7. The method of claim 6, including archiving and updating said collected data in a database.

8. The method of claim 7, wherein the steps of archiving and updating the database is performed automatically.

9. An improved delivery system for delivery and/or pick-up of items comprising: a plurality of locked storage containers at different locations, each locked storage container corresponding to a customer; an order receiver for receiving orders for delivery to and/or pick-up from the customer of one or more goods; availability determiner for determining the availability of the locked storage containers to effect deliveries and/or pick-ups at one or more times; a scheduler receiving availability information from the availability determiner and operable to identify a time interval during which the delivery and/or pick-up can be effected and operable to send to a locked storage container an access signal allowing a delivery agent to access the locked storage container only during the time interval identified by the scheduler; the improvement wherein the delivery system additionally comprises a system for preparing invitations to bid for delivery to and/or pick-up from the at least one locked storage container of the at least one ordered or purchased item; distributing, receiving, and evaluating the bids from a pool of delivery/pick-up agents in an auction; and selecting a delivery agent.

10. The system of claim 9 wherein the auction comprises:
submitting invitations to a pool of potential delivery/pick-up agents to bid on delivering to or picking up from said at least one locked storage container the at least one purchased or ordered item;
receiving bids from members of said pool to carry out said delivery and/or pick-up;
evaluating said bids to determine the identity of the delivery agent selected to effect said delivery and/or pick-up;
selecting a delivery/pick-up agent; and
transmitting authorization to said selected delivery/pick-up agent to effect said delivery and/or pick-up.

11. The system of claim 9 wherein said auction comprises a traditional auction, a reverse auction, a silent auction, a secret auction, or an open auction.
